(19) United States
(12) Patent Application Publication
(10) Pub. No.: US 2004/0205045 A1
(43) Pub. Date: Oct. 14, 2004

(54) Method and system for decision support analysis

(76) Inventors: Li-Wen Chen, Cupertino, CA (US); Rounda Sheng, Saratoga, CA (US)

Correspondence Address: MetaEdge Corporation, 5201 Great America Parkway, Suite 238, Santa Clara, CA, 95054, US

(21) Appl. No.: 09/827,969

(22) Filed: Apr. 4, 2001

(51) Int. Cl. G06F 17/30

(52) U.S. Cl. 707/3

(57) ABSTRACT

The present invention provides techniques for managing and analyzing business information. Specific embodiments provide models that enable persons with business or other non-technical fields understand and manipulate relationships between various data entities in databases, for example. Various applications are supported by specific embodiments. Multidimensional models, statistical computations, rule based systems, report generators, and the like can be used with various specific embodiments in order to enable the decision maker to understand, analyze and present relationships among various information entities.

### BACKGROUND OF THE INVENTION

The present invention relates generally to techniques for providing decision support, and in particular to techniques for visualizing and relationships among marketing and other business information.

Decision support technologies provide business information consumers with tools and techniques for analyzing information. Techniques such as statistics, report generators, such as On Line Analytical Processing (OLAP), and so forth, provide ways for business decision makers to use business information in making business decisions. However, may conventional approaches are often limited in scope or capability, providing only a static view of the whole picture.

While certain advantages to conventional approaches are perceived, opportunities for further improvement exist. For example, according to conventional technologies, modeling of data is done using rudimentary database relationship diagrams. While these diagrams explain the information in a manner understandable to database system programmers and other such persons having a technical background, these methods are not convenient for business and marketing professionals.

What is needed are improved techniques for managing and analyzing information.

### SUMMARY OF THE INVENTION

The present invention provides techniques for managing and analyzing business information. Specific embodiments provide models that enable persons with business or other non-technical fields understand and manipulate relationships between various data entities in databases, for example. Various applications are supported by specific embodiments. Multidimensional models, statistical computations, rule based systems, report generators, and the like can be used with various specific embodiments in order to enable the decision maker to understand, analyze and present relationships among various information entities.

In a representative embodiment according to the present invention, a method for managing information is provided. The method comprises modeling a first plurality of information entities using a first logical model. Then, the logical model is converted into a first derived subject model. Next, the first derived subject model is converted into a first physical model. The method further includes mapping one or more relationships among the first plurality of information entities based upon the first physical model. In a specific embodiment, the method further comprises analyzing the first plurality of information entities using applications based upon input of the first logical model.

In a specific embodiment, the first logical model comprises at least one of a central concept entity, a static attribute entity, a dynamic attribute entity, or an activities/events entity. In a specific embodiment, the first derived subject model comprises at least one of a core component, and at least one of a plurality of customized group components. In a specific embodiment, the mapping one or more relationships between the first entity and the second entity of the first plurality of information entities based upon the first physical model can comprise creating metadata information for the models; and saving the metadata information in a repository.

In a specific embodiment, the method further comprises modeling a second plurality of information entities, including a first entity and a second entity, using a second logical model. Converting the second logical model into a second derived subject model and converting the second derived subject model into a second physical model are also part of the method. Further, the method includes mapping at least one relationship among the first entity and the second entity of the second plurality of information entities based upon the second physical model. In a specific embodiment, the method further comprises analyzing the first plurality of information entities and the second plurality of information entities using applications based upon input from the first logical model and the second logical model. The applications can derive one or more new relationships between the first plurality of information entities and the second plurality of information entities. In specific embodiments, the applications can be one or more of a statistical analysis, a report generator, an On Line Analytical Processing (OLAP) package, and a data mining application, for example.

In another representative embodiment according to the present invention, a system for managing data is provided. The system comprises a computer; an information store, operable to contain the data; a metadata repository, a database interface software process that maintains the data in the information store; a query/command generator software process that provides access to the data; a repository interface software process that provides access to the metadata; a scheduler software process; and a user interface software process that controls input to and output from the metadata repository, database interface software process, the query/command generator software process, and the scheduler.

In a further representative embodiment according to the present invention, a computer program product for managing information is provided. The computer program product comprises code that models a first plurality of information entities, including a first entity and a second entity, using a first logical model. Code that converts the logical model into a first derived subject model and code that converts the first derived subject model into a first physical model are also part of the computer program product. Further, the computer program product includes code that maps at least one relationship among the first entity and the second entity of the first plurality of information entities based upon the first physical model; and a computer readable storage medium for holding the codes.

In a still further representative embodiment according to the present invention, a computer memory is provided. The computer memory has stored thereon data, which comprises a first central concept entity; a first static attribute entity; a first dynamic attribute entity; and a first activities/events entity. The first central concept entity, the first static attribute entity, the first dynamic attribute entity, and the first activities/events entity are related by a first subject model. In a specific embodiment, the computer memory has data stored thereon, which further comprises a second central concept entity; a second static attribute entity; a second dynamic attribute entity; and a second activities/events entity. The second central concept entity, the second static attribute entity, the second dynamic attribute entity, and the second activities/events entity are related by a second subject model.

In a yet further representative embodiment according to the present invention, an apparatus for managing information is provided. The apparatus comprises a processor and a memory. The processor is operative to model a first plurality of information entities, including a first entity and a second entity, using a first logical model. The processor is further operative to convert the logical model into a first derived subject model and to convert the first derived subject model into a first physical model. Further, the processor is also operative to map at least one relationship between the first entity and the second entity of said first plurality of information entities based upon the first physical model. The first entity and the second entity are stored in the memory.

In another representative embodiment according to the present invention, a client apparatus is provided. The apparatus comprises a processor; a memory; and a display. The processor causes the display to display a first logical model, the first logical model modeling a first plurality of information entities, including a first entity and a second entity. Further, the processor causes the display of a first derived subject model, the first derived subject model obtained from the logical model, and the display of a first physical model, the first physical model obtained from the first derived subject model. Further, at least one relationship between the first entity and the second entity of the first plurality of information entities exists based upon the first physical model.

In a further representative embodiment according to the present invention, a method for managing information is provided. The method comprises modeling a first plurality of information entities using a first logical model. Then, the logical model is converted into a first physical model. The method further includes mapping one or more relationships among the first plurality of information entities based upon the first physical model. In a specific embodiment, the method further comprises analyzing the first plurality of information entities using applications based upon input of the first logical model. In a specific embodiment, the first logical model comprises at least one of a central concept entity, a static attribute entity, a dynamic attribute entity, or an activities/events entity.

In a specific embodiment, the method further comprises modeling a second plurality of information entities, including a first entity and a second entity, using a second logical model. Converting the second logical model into a second physical model are also part of the method. Further, the method includes mapping at least one relationship among the first entity and the second entity of the second plurality of information entities based upon the second physical model. In a specific embodiment, the method further comprises analyzing the first plurality of information entities and the second plurality of information entities using applications based upon input from the first logical model and the second logical model. The applications can derive one or more new relationships between the first plurality of information entities and the second plurality of information entities.

In a yet further representative embodiment according to the present invention, a computer program product for managing information is provided. The computer program product comprises code that models a first plurality of information entities, including a first entity and a second entity, using a first logical model. Code that converts the logical model into a first physical model are also part of the computer program product. Further, the computer program product includes code that maps at least one relationship among the first entity and the second entity of the first plurality of information entities based upon the first physical model; and a computer readable storage medium for holding the codes.

In a still further representative embodiment according to the present invention, a method for analyzing information is provided. The method comprises retrieving metadata information from a repository and creating one or more commands based upon the metadata information. Then the commands are sent to a database, and the information received from the database responsive to the one or more commands is provided to one or more applications. Creating one or more reports from a result of the one or more applications is also part of the method. In a specific embodiment, the metadata information comprises at least one of a model, a mapping, a derived attributes definition, and a profiling definition, for example.

In another representative embodiment according to the present invention, a computer program product for analyzing information is provided. The computer program product comprises code that retrieves metadata information from a repository. Code that creates one or more commands based upon the metadata information is also part of the product. Further, code sends the one or more commands to a database; and code that provides information received from the database responsive to the one or more commands to one or more applications; are also part of the computer program product. The product also includes code that creates one or more reports from a result of the one or more applications; and a computer readable storage medium for storing the codes.

In a further representative embodiment according to the present invention, an apparatus for analyzing information is provided. The apparatus comprises a processor; and a memory. The processor is operative to retrieve metadata information from a repository and to create one or more commands based upon the metadata information. The processor also sends the one or more commands to a database and provides information received from the database responsive to the one or more commands to one or more applications. The processor also creates one or more reports from a result of the one or more applications.

In a still further representative embodiment according to the present invention, a client apparatus is provided. The client apparatus comprises a processor; a memory; and a display. The processor causes the display to display one or more reports from a result of one or more applications acting upon information received from a database responsive to one or more commands created based upon a metadata information retrieved from a repository.

Numerous benefits are achieved by way of the present invention over conventional techniques. Specific embodiments according to the present invention provide techniques for working with information to analyze relationships underlying various components of information. Specific embodiments provide models that enable persons with business or other non-technical fields understand and manipulate relationships between various data entities in databases, for example. Various applications are supported by specific embodiments. For example, multidimensional models, statistical computations, rule based systems, report generators, and the like can be used with various specific embodiments in order to enable the decision maker to understand, analyze and present relationships among various information entities.

These and other benefits are described throughout the present specification. A further understanding of the nature and advantages of the invention herein may be realized by reference to the remaining portions of the specification and the attached drawings.

### BRIEF DESCRIPTION OF THE DRAWINGS

FIG. 1 illustrates a representative software architecture capable of supporting a decision support application in a specific embodiment of the present invention.

FIG. 2 illustrates a representative logical model in a specific embodiment of the present invention.

FIG. 3 illustrates a derived subject model in a specific embodiment of the present invention.

FIG. 4 illustrates a physical model in a specific embodiment of the present invention.

FIG. 5 illustrates a representative logical model in a specific embodiment of the present invention.

FIG. 6 illustrates a derived subject model in a specific embodiment of the present invention.

FIG. 7 illustrates a physical model in a specific embodiment of the present invention.

FIG. 8 illustrates a representative display of information in a specific embodiment of the present invention.

FIG. 9 illustrates a representative architecture of a system suitable of embodying a decision support application in a specific embodiment of the present invention.

FIG. 10 illustrates a diagram of a representative overview of relationships between various processes and components in a specific embodiment of the present invention.

FIGS. 11A-11F illustrate flowcharts of representative processing in various specific embodiments of the present invention.

FIG. 12 illustrates a representative multi-subject model in a specific embodiment of the present invention.

FIG. 13 illustrates a representative computer system suitable for implementing a specific embodiment of the present invention.

### DESCRIPTION OF THE SPECIFIC EMBODIMENTS

The present invention provides techniques for managing and analyzing business information. Specific embodiments provide models that enable persons with business or other non-technical fields understand and manipulate relationships between various data entities in databases, for example.

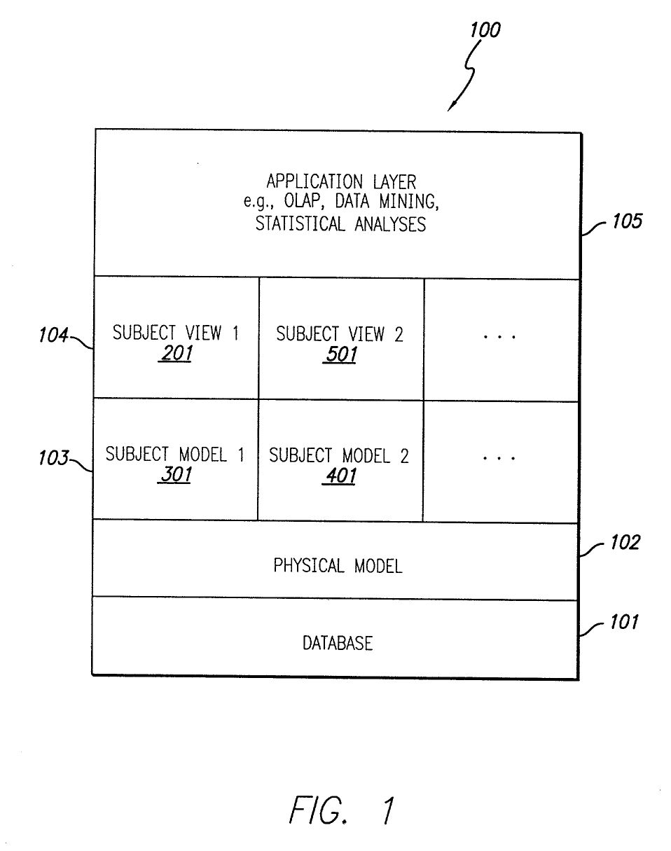

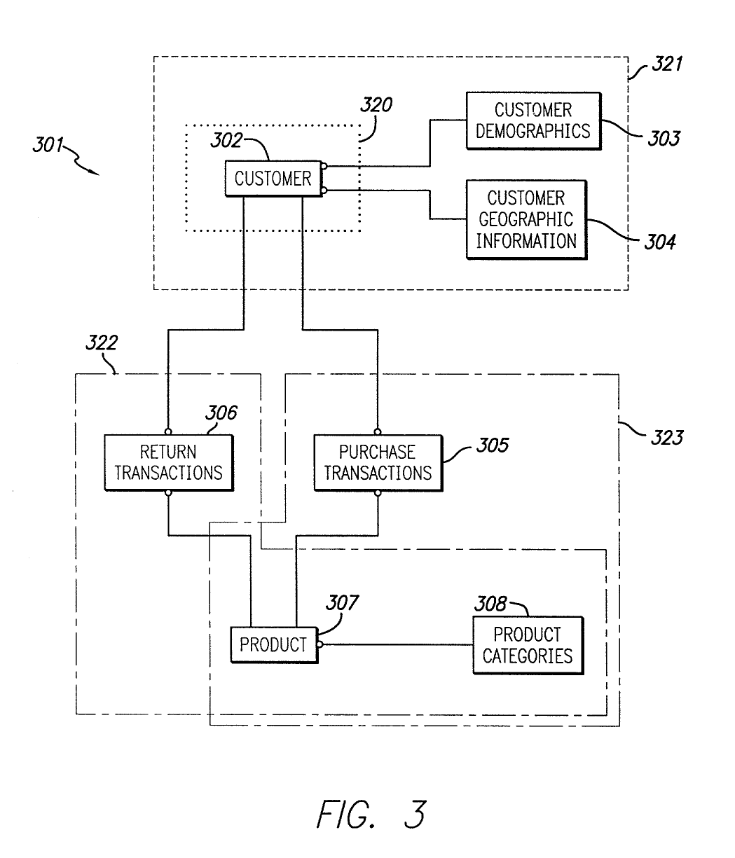

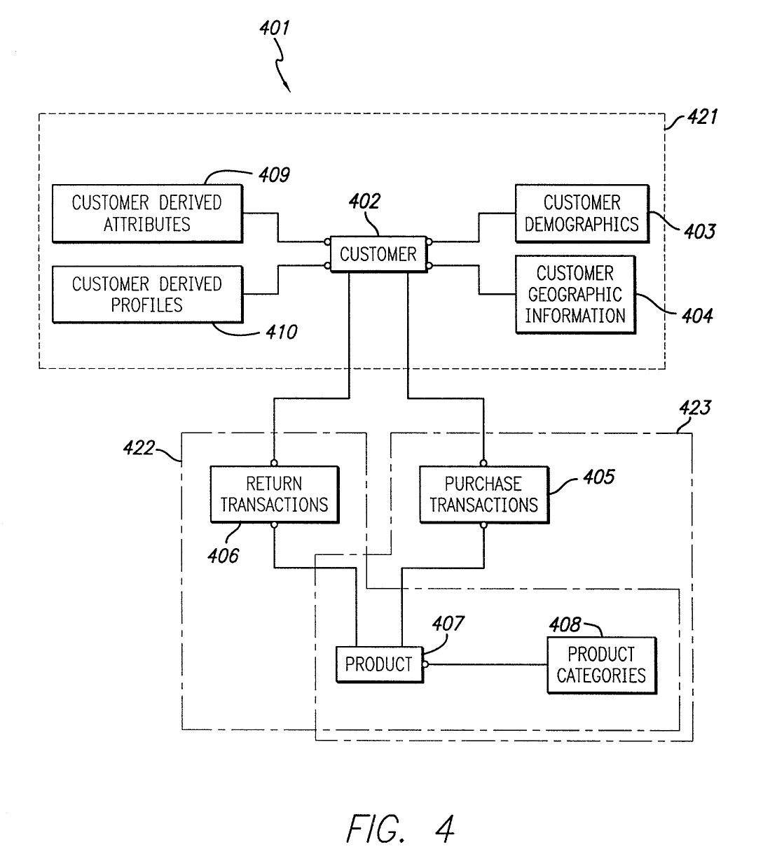

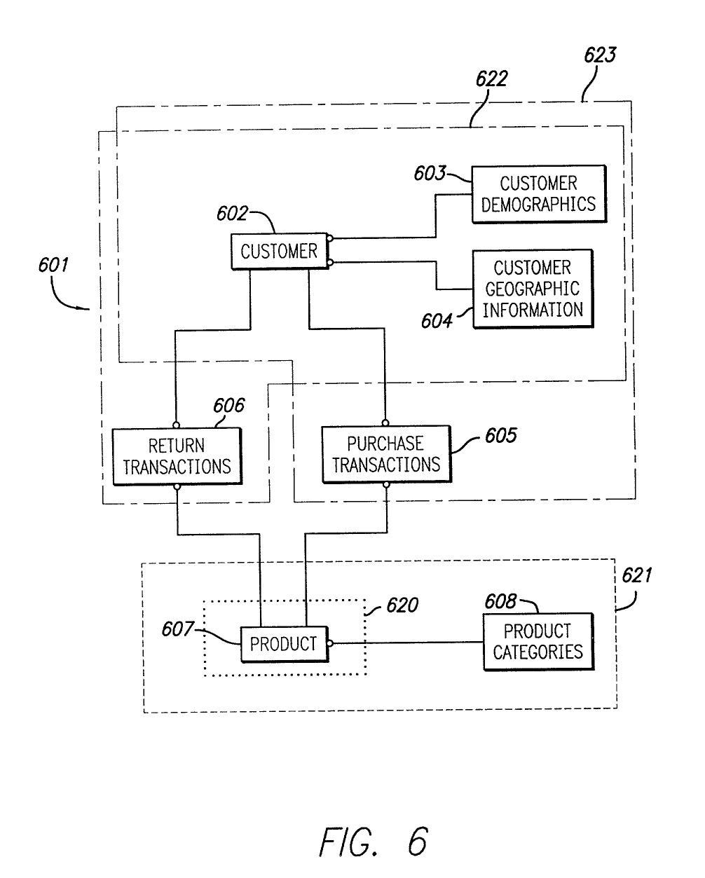

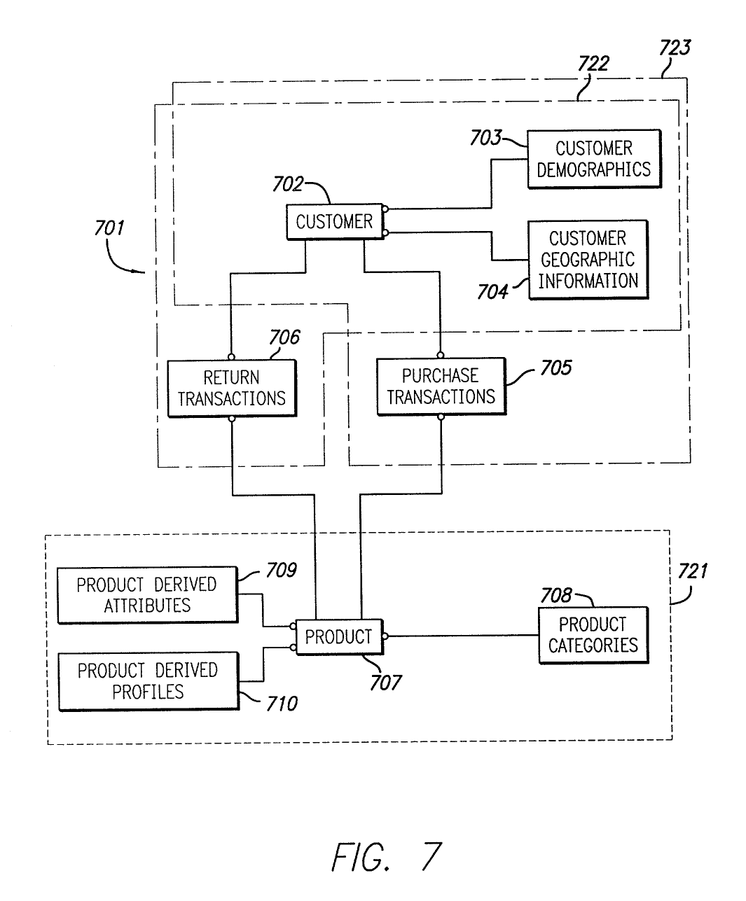

FIG. 1 illustrates a representative software architecture capable of supporting a decision support application in a specific embodiment of the present invention. As shown by FIG. 1, an architecture diagram 100 comprises of a database 101 that contains information about a business process in a specific embodiment. The database 101 contains a plurality of data elements. The data contained within database 101 may be organized in a variety of different ways, which may be called schema. In a specific embodiment, database 101 is a relational database. Relationships between various data elements within database 101 are conceptualized by a physical model 102. Physical models, also known as relational models, provide one or more relationships between information elements, such as a customer, a transaction, a product, and so forth, stored in the relational database 101. Representative examples of physical models will be described herein with reference to specific embodiments of FIGS. 4 and 7. Physical model 102 may be derived from one or more subject models, such as subject model 103. Subject model 103 comprises a reverse star schema (RSS) relationship among a plurality of data elements stored in the database 101. Subject model 103 provides a way for users and consumers of the data in database 101 to think about the relationships among the data in a useful way. Representative examples of subject models will be described herein with reference to specific embodiments of FIGS. 3 and 6.

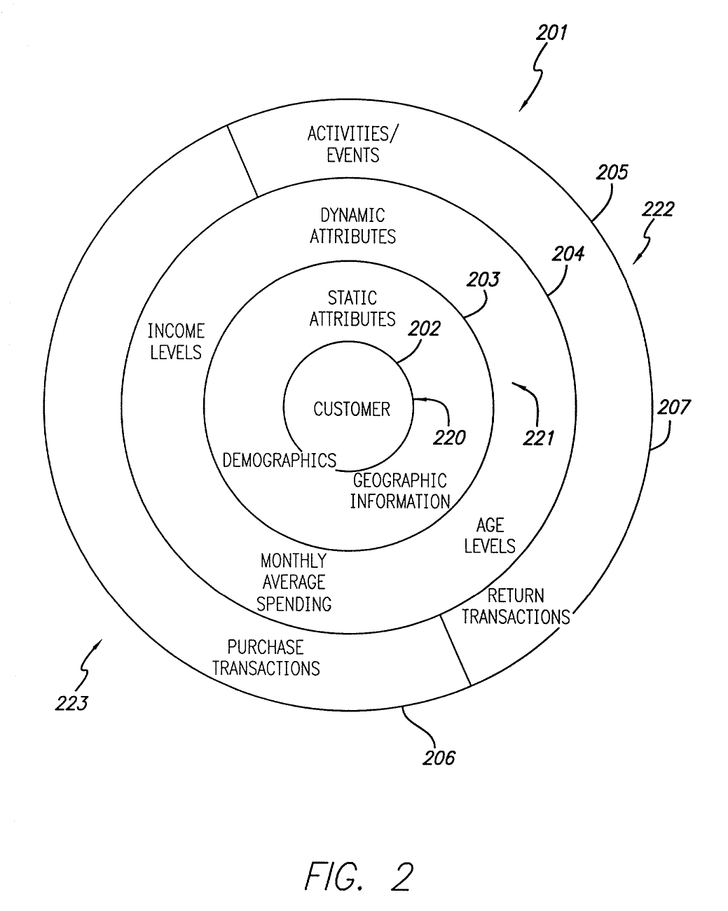

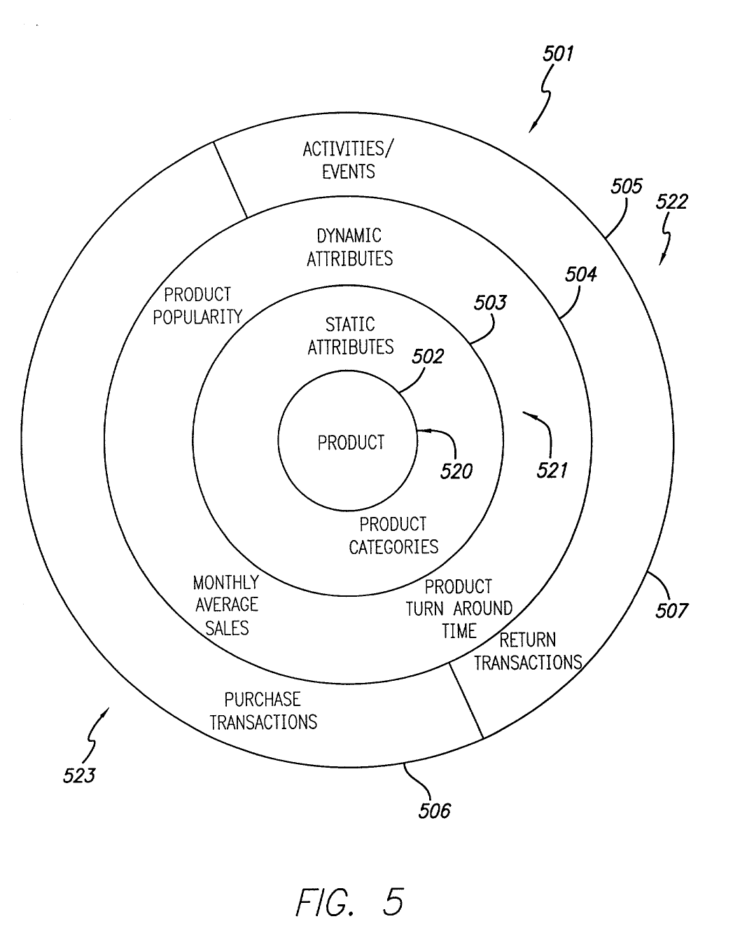

One or more logical models, such as logical model 104, provide a subject view of the relationships described by the subject model 103. Logical model 104 centers about a single concept, such as a customer, or a product, for example, that is the focus of one or more business analyses. Logical models provide a way for users and consumers of the data in database 101 to view relationships between different data elements in the database 101 in a hierarchical way. Representative examples of logical models will be described herein with reference to specific embodiments of FIGS. 2 and 5.

The logical models support applications at an application layer 105. Applications, such as OLAP, statistical models, and so forth, are used in various specific embodiments of the present invention. The specific embodiment having a software architecture shown in FIG. 1 supports a multiple subject system, which is an environment in which different applications run using the data stored in the database 101. Accordingly, more than one subject model 103 and more than one subject view 104 may be included in some specific embodiments of the present invention.

FIG. 2 illustrates a representative logical model in a specific embodiment of the present invention. In FIG. 2, a logical model 201 for a single subject system in a specific embodiment is shown. Logical model 201 comprises a single subject: customer, which is the center concept 202 of logical model 201. Surrounding the center concept 202 are one or more static attributes 203, such as demographics of a customer, or geographic information about a customer. Further, one or more dynamic attributes 204 may be derived from the static attributes and activities/events 205. For example, one or more age levels may be derived from demographic information about the customer. Further, one or more activities and events 205 may be defined for the center concept 202. For example, a purchase transaction and a return transaction are activities/events relating to the center point customer. Accordingly, in FIG. 2, the customer is the center concept 202, while geographic information and demographics are static attributes 203. These are merely representative examples of the many possible static attributes that may be used in various specific embodiments of the present invention. Purchase transactions 206 and return transactions 207 are examples of activities/events 205. Surrounding the static attributes 203 are one or more dynamic attributes 204, which may be derived from the static attributes 203 and/or from one or more activities and events 205. For example, one or more age levels, a dynamic attribute, may be derived from demographic information about the customer, a static attribute. One or more activities and events 205 may be defined for the center concept 202. Dynamic attributes 204 can also be derived from activities/events 205. For example, a monthly average spending level can be derived from the purchase transactions 206 information belonging to the activities/events 205. Accordingly, a user may derive various dynamic attributes and profiles about the center concept 202 of the logical model 201, such as an age level, an income level, a monthly average spending level, and so forth. Dynamic attributes 204, static attributes 203 and center concept 202 comprise a focal group 221. Activities/events 205 are divided into customized groups. A core component 220 comprises center concept 202. A first customized group 223 comprises information entities in purchase transactions 206, as well as lookup information related to products involved in the transactions (not shown). A second customized group 222 comprises return transactions 207, as well as lookup information related to products involved in the transactions (not shown).

FIG. 3 illustrates a derived subject model in a specific embodiment of the present invention. In FIG. 3, a derived subject model 301 corresponding to the logical subject model 201 of FIG. 2 in a specific embodiment is shown. Derived subject model 301 comprises a plurality of relationships between a plurality of groups and information entities in database 101, as illustrated by logical model 201. Logical model 201 provides a customer centric view, with the center concept 202 being customer. Accordingly, the derived subject model 301 comprises a customer entity 302. Static attributes are represented by a customer demographics entity 303, which comprises demographics information for each customer in customer entity 302, and a customer geographic entity 304, which comprises geographical information about each customer in customer entity 302. A purchase transaction entity 305 comprises merchant purchase transaction data, such as a time, a date, an amount, a description, and so forth, for a plurality of purchase transactions entered into by customers in customer entity 302. A return transaction entity 306 comprises merchant return transaction data, such as a time, a date, and a returning item, and so forth, for a plurality of return transactions entered into by customers in customer entity 302.

A product entity 307 comprises product information that describes the merchant and its characteristics, such as a product name, a description, a price, and so forth. A product categories entity 308 comprises product classification information. In a specific embodiment, the entities comprising the derived subject model 301 have a reverse star schema arrangement, with the customer entity 302 comprising a core component 320, as indicted by a dotted line in FIG. 3. Customer entity 302, customer demographics entity 303 and customer geographic entity 304 comprise a focal group 321. A first customized group 322 comprising of return transaction entity 306, product entity 307 and product categories entity 308 provides information related to the core component 320, customer entity 302. A second customized group 323 comprising of purchase transaction entity 305, product entity 307 and product categories entity 308 provides another set of information related to the core component 320, the customer entity 302. Accordingly, the remainder of the information entities in the derived subject model 301 are arranged according to their relationships with the core component 320. A variety of other arrangements and relationships among the entities in the derived subject model 301 may also be used in various specific embodiments according to the present invention.

FIG. 4 illustrates a physical model in a specific embodiment of the present invention. In FIG. 4, a physical model 401 corresponding to the derived subject model 301 of FIG. 3 in a specific embodiment is shown. Physical model 401 is a relational model that illustrates relationships between entities of customer, transaction, and product that are incorporated in information stored in the database 101. In a specific embodiment, the database is a relational database, however, other methods of storing and retrieving information may be used in various other specific embodiments as will be evident to those skilled in the art. In physical model 401, a plurality of dynamic attributes and profiles have been derived from the derived subject model 301. A star schema organization of the data entities in the focus group 421 is created dynamically by a software process in a specific embodiment. In a specific embodiment, C-INSight™, a product of MetaEdge Corporation, of Sunnyvale, Calif., provides the capability to dynamically derive attributes and profiles from static data and to create a star schema, and, hence a multidimensional cube, dynamically.

The physical model 401 comprises a customer entity 402 that is central to the focus group 421. Static attributes are represented by a customer demographics entity 403, which comprises demographics information for each customer in customer entity 402, and a customer geographic entity 404, which comprises geographical information about each customer in customer entity 402. One or more dynamically derived attributes may also comprise focus group 421. For example, in a specific embodiment illustrated by FIG. 4, a customer derived attributes 409 and a customer derived profiles 410 include derived information about customers in customer entity 402.

A first customized group 422 comprises a return transactions entity 406, which comprises merchant return transaction data, such as a time, a date, and a returning item, and so forth, for a plurality of return transactions entered into by customers in customer entity 402. Further, customized group 422 comprises a product entity 407, which comprises product information that describes the merchant and its characteristics, such as a product name, a description, a price, and so forth, and a product categories entity 408, which comprises product classification information.

A second customized group 423 comprises a purchase transaction entity 405, which comprises merchant purchase transaction data, such as a time, a date, an amount, a description, and so forth, for a plurality of purchase transactions entered into by customers in customer entity 402. Customized group 423 further comprises product entity 407, and product categories entity 408.

FIG. 5 illustrates a representative logical model in a specific embodiment of the present invention. In FIG. 5, a logical model 501 for a single subject system in a specific embodiment is shown. Logical model 501 comprises a single subject: product, which is the center concept 502 of logical model 501. Surrounding the center concept 502 are one or more static attributes 503. Static attributes 503, such as product categories, for example, comprise information relating to the subject at the center concept 502, product, in the specific embodiment in FIG. 5. Here, product categorization is one example of a static attribute 503. This is merely a representative example of the many possible static attributes that may be used in various specific embodiments of the present invention. Surrounding the static attributes 503 are one or more dynamic attributes 504, which may be derived from the static attributes 503 and/or from one or more activities and events 505. One or more activities and events 505 may be defined for the center concept 502. For example, purchase transaction and return transactions are representative activities/events for product center concept 502. If a business enterprise has inventory, another category for inventory may be added to activities/events 505. A dynamic attribute, such as a number of products per category, for example, may be derived from product category information about the product, which is a static attribute 503. Dynamic attributes 504 can also be derived from activities/events 505. For example, a monthly average sales per product can be derived from the purchase transactions information belonging to the activities/events 505. Accordingly, a user may derive various dynamic attributes and profiles about the center concept 502 of the logical model 501. For example, dynamic attributes such as an average monthly sales, a product turn around time, a product popularity (purchase-return) level, and so forth, may be derived in specific embodiments of the present invention. Center concept 502 comprises a core component 520. Dynamic attributes 504, static attributes 503 and center concept 502 comprise a focal group 521. Activities/events 505 are divided into customized groups. A first customized group 523 comprises information entities in purchase transactions 506, as well as lookup information related to customers involved in the transactions (not shown). A second customized group 522 comprises return transactions 507, as well as lookup information related to customers involved in the transactions (not shown).

FIG. 6 illustrates a derived subject model in a specific embodiment of the present invention. In FIG. 6, a derived subject model 601 corresponding to the logical subject model 501 of FIG. 5 in a specific embodiment is shown. Derived subject model 601 comprises a plurality of relationships between a plurality of groups and information entities in database 101, and illustrated by logical model 501, which provides a product centric view. The derived subject model 601 comprises a central concept 607 of a product. A product categories entity 608 comprises category and other information about the product entity 607. Product entity 607 comprises a core component 620, which is indicated by a dotted line in FIG. 6. Further, product entity 607 and product categories entity 608 comprise a focal group 621, indicated by a dashed line in FIG. 6.

A purchase transaction entity 605 comprises merchant purchase transaction data, such as a time, a date, an amount, a description, and so forth, for a plurality of purchase transactions of products in product entity 607. A return transaction entity 606 comprises merchant return transaction data, such as a time, a date, and a returning item, and so forth, for a plurality of return transactions for products in product entity 607.

A customer entity 602 comprises information that describes each individual customer. A customer demographics entity 603 comprises demographics information for each customer in customer entity 602. A customer geographic entity 604 comprises geographical information about each customer in customer entity 602. In a specific embodiment, the entities comprising the derived subject model 601 have a reverse star schema arrangement, with the product entity 607 comprising a core component 620, as indicted by a dotted line in FIG. 6. Product entity 607 and product categories entity 608 comprise a focal group 621. A first customized group 622 comprising return transaction entity 606, customer entity 602, customer demographics entity 603, and customer geographic information entity 604 provides information related to the core component 620, which comprises product entity 607. A second customized group 623 comprising purchase transaction entity 605, customer entity 602, customer demographics entity 603, and customer geographic information entity 604 provides another set of information related to the core component 620, which comprises the product entity 607. Accordingly, the remainder of the information entities in the derived subject model 601 are arranged according to their relationships with the core component 620. A variety of other arrangements and relationships among the entities in the derived subject model 601 may also be used in various specific embodiments according to the present invention.

FIG. 7 illustrates a physical model in a specific embodiment of the present invention. In FIG. 7, a physical model 701 corresponding to the derived subject model 601 of FIG. 6 in a specific embodiment is shown. Physical model 701 is a relational model that illustrates relationships between entities of customer, transaction, and product that are incorporated in information stored in the database 101 in FIG. 1. In a specific embodiment, the database is a relational database, however, other methods of storing and retrieving information may be used in various other specific embodiments as will be evident to those skilled in the art. In physical model 701, a plurality of dynamic attributes and profiles have been derived from the derived subject model 601 in FIG. 6. A star schema organization of the data entities in the focus group 721 is created dynamically by a software process in a specific embodiment. In a specific embodiment, C-INSight™, a product of MetaEdge Corporation, of Sunnyvale, Calif., provides the capability to dynamically derive attributes and profiles from static data.

The physical model 701 comprises a product entity 707 that is central to the focus group 721. Product entity 707 comprises product information that describes the merchant and its characteristics, such as a product name, a description, a price, and so forth. Static attributes are represented by a product categories entity 708, which comprises product classification information. One or more dynamically derived attributes may also comprise focus group 721. For example, in a specific embodiment illustrated by FIG. 7, a product derived attributes 709 and a product derived profiles 710 include derived information about customers in customer entity 707.

A first customized group 722 comprises a return transactions entity 706, which comprises merchant return transaction data, such as a time, a date, and a returning item, and so forth, for a plurality of return transactions. Further, customized group 722 comprises a customer entity 702, a customer demographics entity 703, which comprises demographics information for each customer in customer entity 702, and a customer geographic entity 704, which comprises geographical information about each customer in customer entity 702.

A second customized group 723 comprises a purchase transaction entity 705, which comprises merchant purchase transaction data, such as a time, a date, an amount, a description, and so forth, for a plurality of purchase transactions entered into by customers in customer entity 702. Customized group 723 further comprises customer entity 702, customer demographics entity 703, which comprises demographics information for each customer in customer entity 702, and customer geographic entity 704, which comprises geographical information about each customer in customer entity 702.

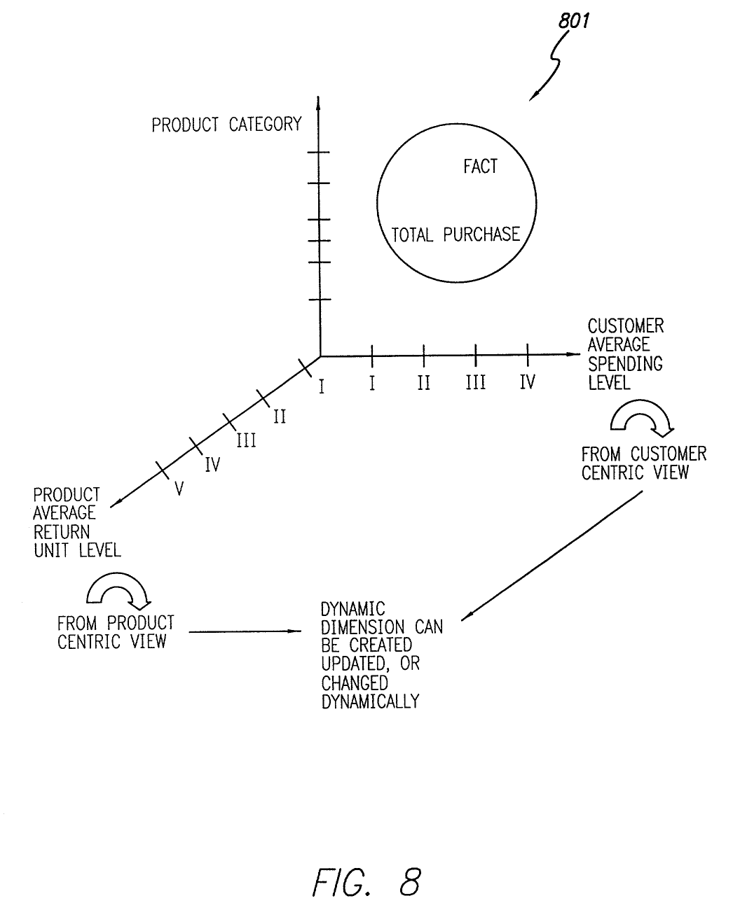

FIG. 8 illustrates a representative display of information in a specific embodiment of the present invention. In FIG. 8, a multidimensional visual display 801, which in a specific embodiment has 3-dimensions, is used to depict relationships among data in the database 101. Display 801 has dimensions of a customer average spending level, which comprises four spending levels, along the x-direction; a product average returns, which is an indicator of product popularity that categorizes products based upon product return transaction data, which comprises five levels, along the y-direction; and a product category along the z-direction. A total purchase information is a fact represented by graphing data in the database 101 according to the dimensions x, y, and z that have been selected. Accordingly, each number that is graphed in the fact illustrated by FIG. 8 is based upon a product category, customer spending level, and product popularity.

Customer average spending level information depicted along the x-direction is derived from a customer centric view, as illustrated by the logical model 201 in FIG. 2. Product average returns depicted along the Y-direction and product category depicted along the z-direction are derived from a product centric view, as illustrated by the logical model 501 in FIG. 5. Since what is graphed may be derived dynamically, in specific embodiments, it is possible to easily change the report, graph, and so forth. Accordingly, with the same physical model, users can view different relationships among the information for analysis.

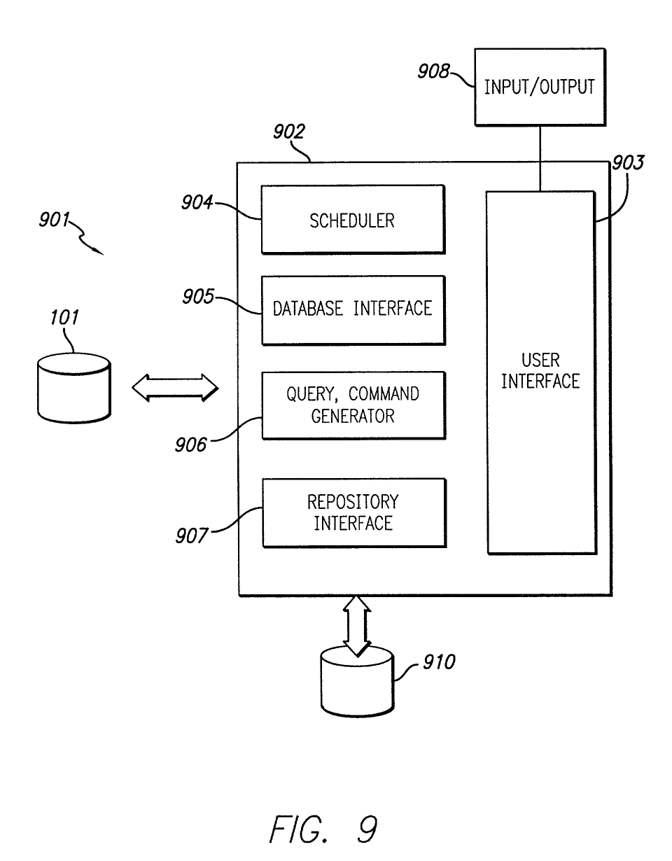

FIG. 9 illustrates a representative architecture of a system suitable for embodying a decision support application in a specific embodiment of the present invention. As shown in FIG. 9, in a specific embodiment, a system 901 for managing and analyzing information comprises a computer system 902, coupled to database 101, a metadata repository 910, and an optional input/output device(s) 908, which can be a console, display screen or the like. In specific embodiments, metadata repository 910 may be combined with or co-located with database 101. In some specific embodiments, one or both of metadata repository 910 and database 101 may be located on the computer system 902, while in alternative embodiments, one or both of metadata repository 910 and database 101 may be located on another computer system (not shown), which may be a server computer, for example. In some specific embodiments, a network may connect computer system 902 with a server computer having access to database 101 and/or metadata repository 910, so that a client-server relationship is established. However, a client-server relationship is not necessary to practice the invention.

A plurality of software processes resident on computer system 902 provide various functions to the user. For example, a database interface software process 905 maintains the information in the database 101. A query/command generator software process 906 provides access to the information in the database 101. A scheduler software process 904 coordinates the events and actions in the computer system 902. A repository interface software process 907 provides an interface to metadata repository 910. A user interface software process 903 enables users to create and view logical models, subject models and physical models, and the like. Further, in various specific embodiments, users can create applications such as 3-dimensional diagrams, such as display 801 of FIG. 8, for example, reports, perform data mining, enter, edit and apply rules, compute statistics, and so forth using applications and facilities of computer system 902.

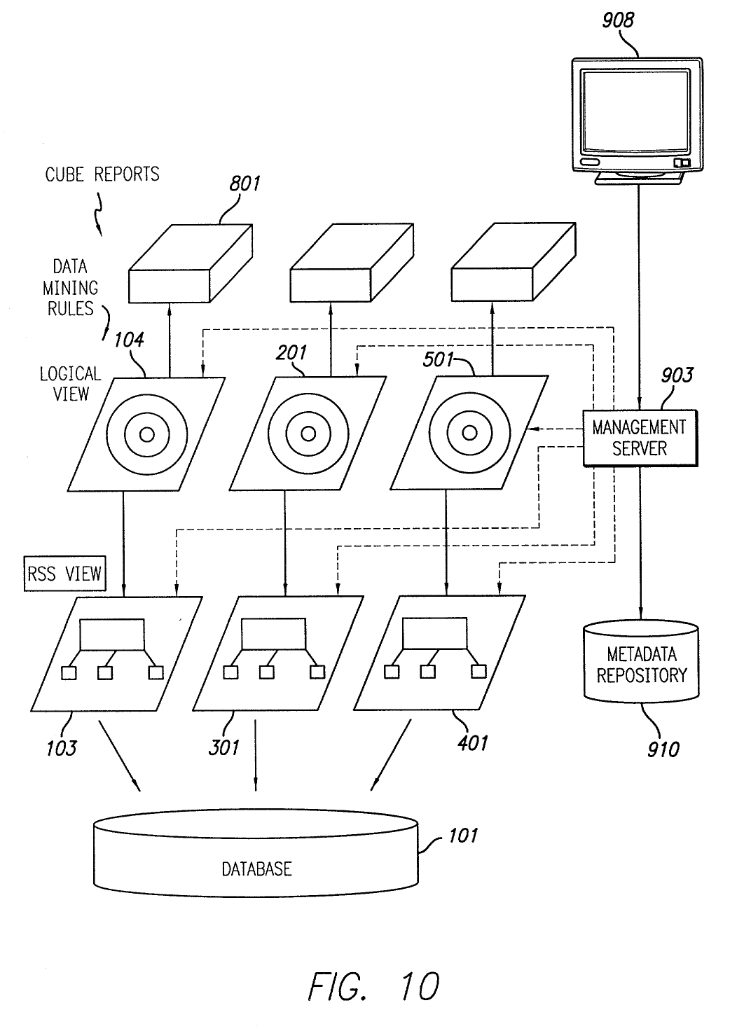

FIG. 10 illustrates a diagram of a representative overview of relationships between various processes and components in a specific embodiment of the present invention. As shown in FIG. 10, in a specific embodiment, database 101 holds business data. A plurality of subject models 103, such as subject model 301 and subject model 401, for example, provide viewable models of the physical schema (not shown) of the relationships in the information contained in the database 101. A plurality of subject views are provided by logical models 104, such as logical model 201 and logical model 501 for example, which provide users the capability to conceptualize and visualize relationships among data in the schema of subject models 103 at a high level. Applications such as 3 dimensional visual display 801, which is an OLAP example that is represented by a cube shape, enable business decision makers to analyze the information of database 101 as conceptualized by the logical models 104. Data mining is another application example. Business decision makers can leverage these data models to prepare data for data mining applications. Data represented in the subject models 103 can be provided to the data mining application. Further, business rules created by data mining applications can also be provided to the data models, and to an OLAP application, for example, for visualization in a specific embodiment. Computer system 902 performs processing to create, manage, and manipulate the various views and models based upon the information in the database 101. Computer system 902 may also manage the information in the database 101, and perform searches of the database 101 in a specific embodiment. In some specific embodiments, computer system 902 is connected to a metadata repository 910 and/or an input/output device 908.

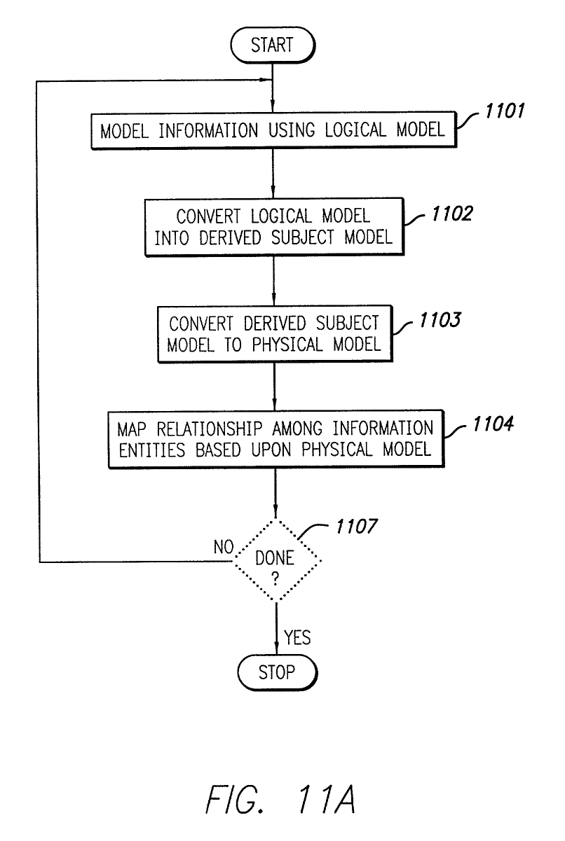

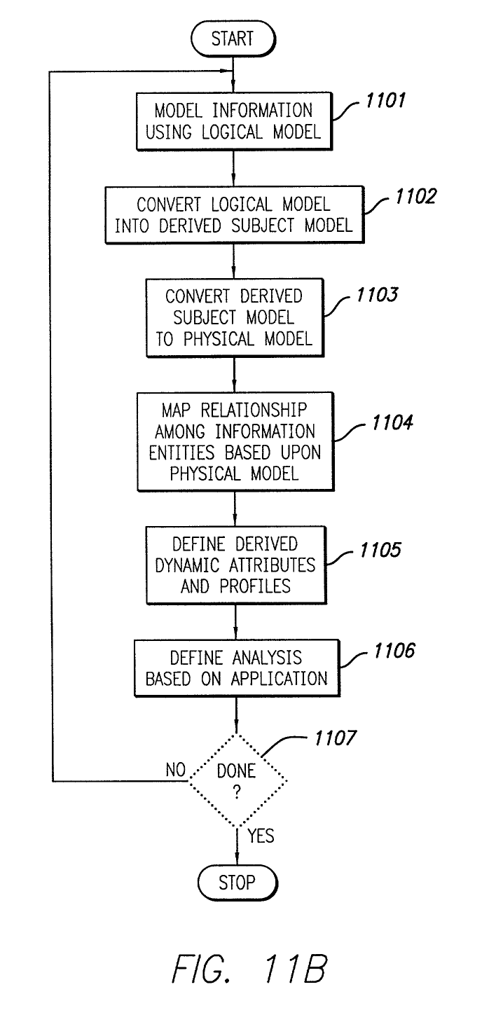

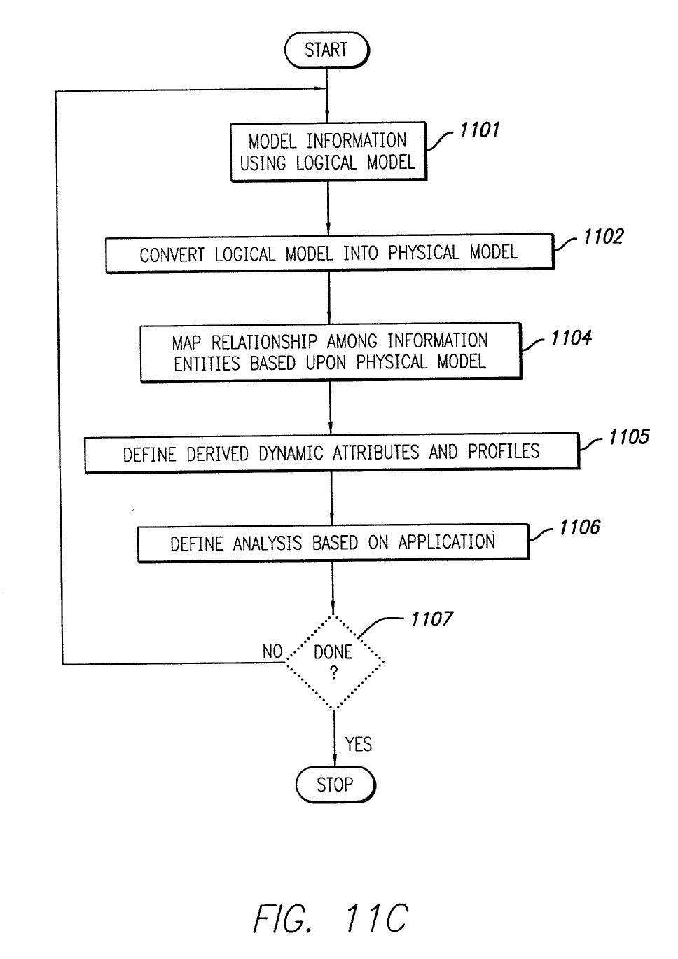

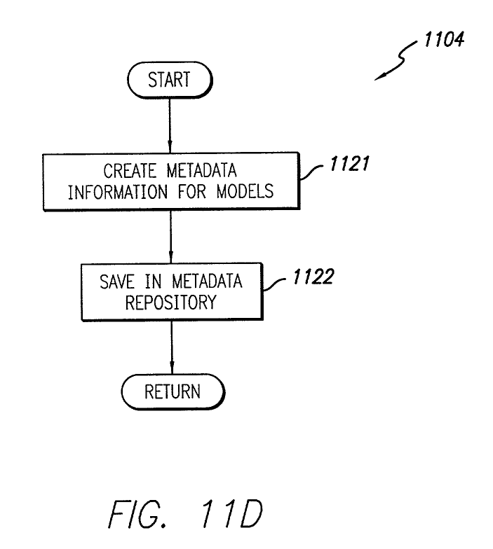

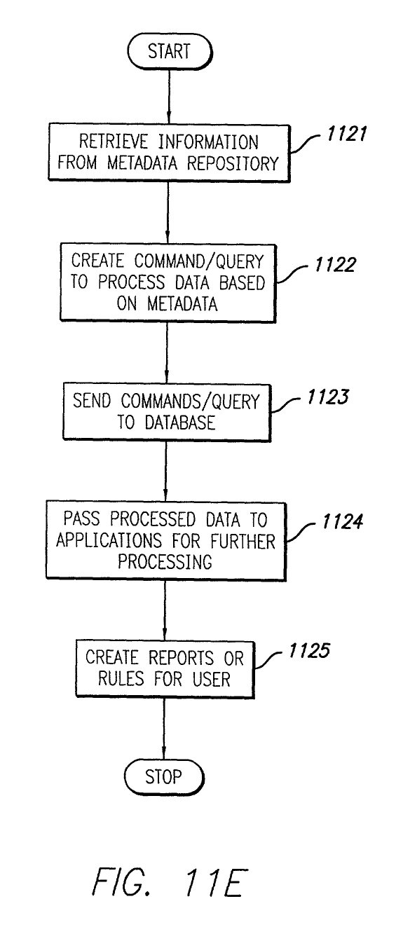

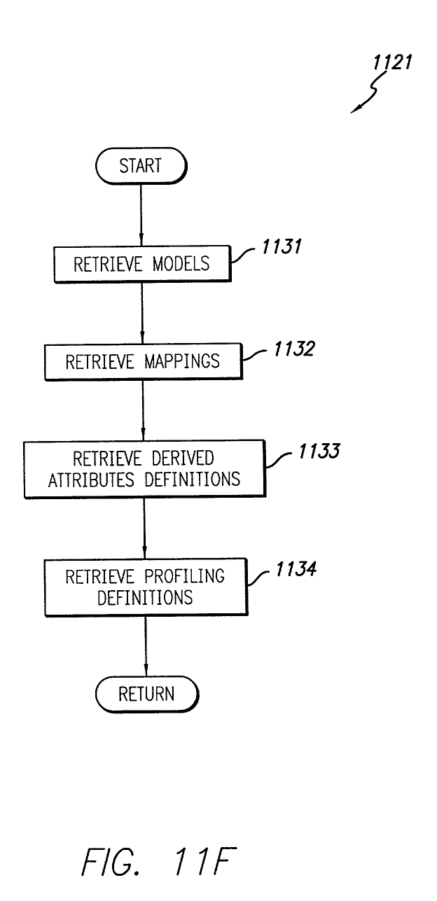

FIGS. 11A-11F illustrate flowcharts of representative processing in various specific embodiments of the present invention. Specific embodiments such as the representative specific embodiments discussed with reference to FIGS. 11A-11D may be useful in creating models of information in a database and reducing the models to metadata, for example. Specific embodiments such as the representative specific embodiments discussed with reference to FIGS. 11E-11F may be useful in analyzing information using the metadata, for example. However, other useful applications of the varied specific embodiments of the present invention are readily apparent to those skilled in the art. In one specific embodiment, as illustrated in FIG. 11A, a first plurality of information is modeled using a first logical model (1101). Then, the logical model is converted into a first derived subject model (1102). Next, the first derived subject model is converted into a first physical model (1103). The method also includes mapping at least one relationship among the first plurality of information in the database based upon the first physical model (1104). Optionally, a check can be performed in some specific embodiments, to determine if a user would like to iteratively perform the method again to refine the model (1107).

In another specific embodiment, as illustrated by FIG. 11B, a first plurality of information is modeled using a first logical model (1101). Then, the logical model is converted into a first derived subject model (1102). Next, the first derived subject model is converted into a first physical model (1103). The method also includes mapping at least one relationship among the first plurality of information in the database based upon the first physical model (1104). Then, dynamic attributes and profiles can be derived (1105). The method also includes defining analyses based on available applications (1106). Optionally, a check can be performed in some specific embodiments, to determine if a user would like to iteratively perform the method again to refine the model (1107).

In a yet further specific embodiment, as illustrated by FIG. 11C, a first plurality of information is modeled using a first logical model (1101). Then, the logical model is converted into a first physical model (1102). The method also includes mapping at least one relationship among the first plurality of information in the database based upon the first physical model (1104). Then, dynamic attributes and profiles can be derived (1105). The method also includes defining analyses based on available applications (1106). Optionally, a check can be performed in some specific embodiments, to determine if a user would like to iteratively perform the method again to refine the model (1107).

FIG. 11D illustrates a flowchart of a representative mapping process in various specific embodiments of the present invention. As illustrated by FIG. 1 ID, in some specific embodiments, mapping process 1104 comprises a plurality of sub-processes, such as creating metadata information for the models (1121) and saving the metadata information into a metadata repository 910 of FIG. 9 (1122), for example.

FIG. 11E illustrates a flowchart of a representative run time process in a specific embodiment of the present invention. As illustrated by FIG. 11E, information is retrieved from the metadata repository 910 (1121). Next, command/queries are created in order to process data based upon the metadata (1122). These commands are sent to the database 101 (1123). Information retrieved from the database 101 responsive to the commands is passed to applications for further processing (1124). Then, the results of the processing by theses applications is used to create reports or rules for a user (1125).

FIG. 11F illustrates a flowchart of a representative information retrieving process in various specific embodiments of the present invention. As illustrated by FIG. 11F, in some specific embodiments, information retrieving process 1121 comprises a plurality of sub-processes, such as retrieving models (1131), retrieving mappings (1132), retrieving derived attributes definitions (1133), and retrieving profiling definitions (1134), for example. In various specific embodiments, one or more of these items will be retrieved as part of the information retrieving process 1121. In some specific embodiments, other information entities not shown here may also be retrieved. Further, in alternative specific embodiments, some of the information entities shown here will not be included, or may be retrieved in different order, or retrieved concurrently, as will be apparent to those skilled in the art.

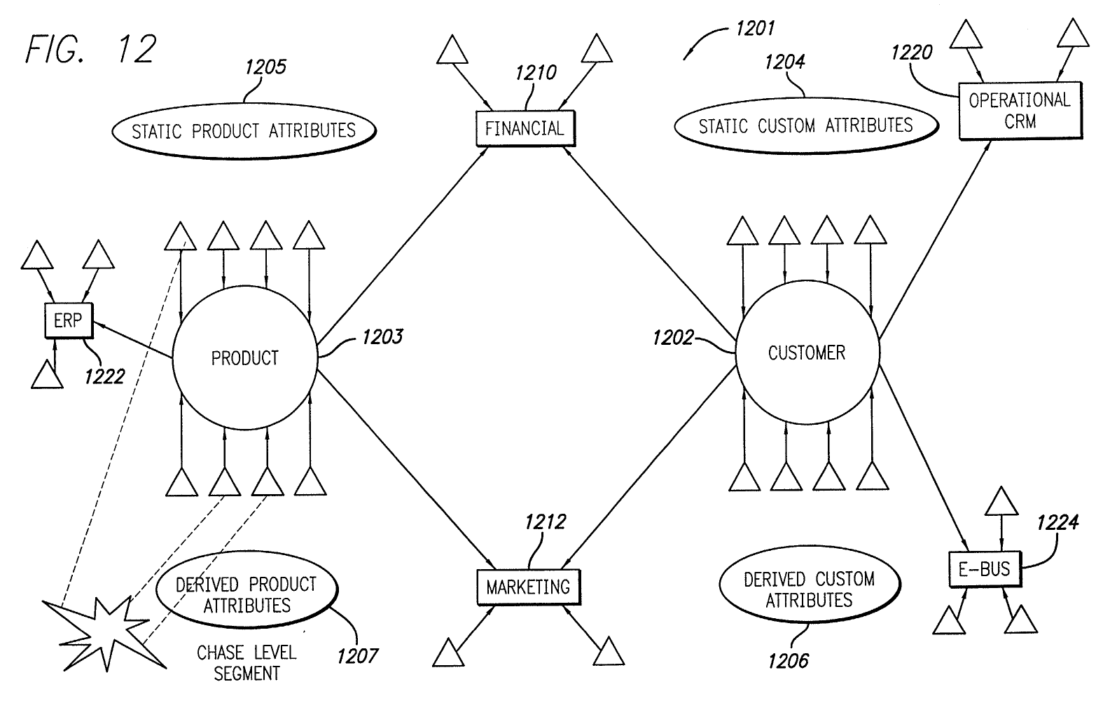

FIG. 12 illustrates a representative multi-subject model in a specific embodiment of the present invention. As shown in FIG. 12, a logical model 1201 comprises two subjects, indicated by a customer focal group 1202, from a customer centric logical model 201, and a product focal group 1203, from a product centric logical model 501. Each subject comprises static and dynamic attributes. In the representation shown in FIG. 12, individual attributes, as well as other individual entities are denoted by triangles. For example, in the customer focal group 1202, there are static attributes 1204, which can include attributes such as customer geographic information, customer demographic information, and so forth. In the product focal group 1203, there are static attributes 1205, which can include attributes such as product categories, product location, and so forth. In a specific embodiment, from each focal group of the multi-subject model 1201, one or more derived attributes may be generated. These attributes are derived by deriving data from activities exercised by an external system, such as an operational Customer Relationship Management (CRM) system 1220, an e-Business system 1221, or an Enterprise Resource Planning (ERP) system 1222, for example. For example, in the product focal group 1203, derived attributes 1207 include a product popularity, a product turn around time, and so forth. In the customer focal group 1202, derived attributes 1206 include a monthly average spending, and so forth.

The customer focal group 1202 and the product focal group 1203 can provide information, as well as, extend types of access, or views, to the information available to a financial data mart 1210 and a marketing data mart 1212. For example, the marketing data mart 1212 may initially contain customer response information for a marketing campaign based upon product category and customer segments. By aggregating information such as inventory supplies, delivery times, shipment amounts and so forth, obtained from an external system, such as ERP system 1222, a plurality of dynamic attributes 1207 can be derived for the product categories. Similarly, dynamic attributes 1206 may be derived by aggregating customer purchase information, such as a frequency of purchase, from another external system, e-Business system 1221, for example, with information from customer group 1202. Accordingly, a marketing executive can understand marketing response rates based upon these derived attributes 1206 from customer focal group 1202 and derived attributes 1207 from product focal group 1203 in order to design a marketing campaign.

In a specific embodiment, derived attributes and static attributes can be segmented. For example, returns and/or purchases can be segmented into various levels, such as a 0-1000 units, 1001-2000 units, and so forth. Similarly, customers may be segmented by income and/or age levels, for example, as well. The multi-subject model 1201 enables static and/or derived attributes, as well as segmentations aggregated from the actual activities, to be incorporated into a decision support system (DSS) model, so that meaningful information generated from a product group 1205 can be used by analyses of the customer group 1202 and vice versa.

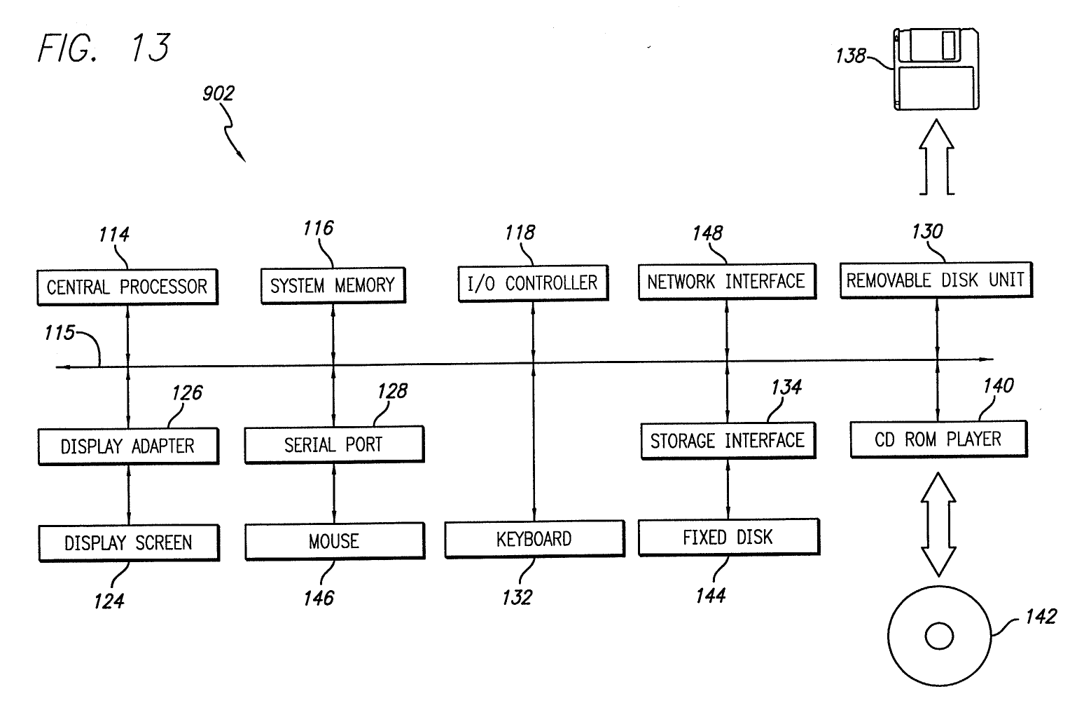

FIG. 13 illustrates a representative computer system suitable for implementing a specific embodiment of the present invention. As shown in FIG. 13 a computer system 902 suitable for embodying a specific embodiment of the invention. Computer system 902 includes a bus 115 which interconnects a variety of components and subsystems. Bus 115 interconnects a central processor 114, a system memory 116, an input/output controller 118, a display screen 124 via a display adapter 126, a serial port 128, a keyboard 132, a fixed disk drive 144 via storage interface 134, and a removable disk drive 136. Removable disk drive 136 is operative to receive a removable disk 138. Many other devices may be connected to bus 115. For example, an external device such as a printer (not shown), and/or a scanner (not shown) may be connected via an I/O controller 118. Mouse 146 can be connected to serial port 128. A network interface 148 can be included to provide connectivity to one or more networks, including the Internet. Many other devices and subsystems (not shown) may be connected in a similar manner. Also, it is not necessary for all of the devices shown in FIG. 13 to be present to practice the present invention. Further, the devices and subsystems may be interconnected in different ways from that shown in FIG. 13 in various specific embodiments. Source code to implement the present invention may be operatively disposed in system memory 116 and/or stored on storage media such as fixed disk 144 or removable disk 138.

The preceding has been a description of the preferred embodiment of the invention. It will be appreciated that deviations and modifications can be made without departing from the scope of the invention, which is defined by the appended claims. The diagrams included herein are merely an illustration of specific embodiments and should not limit the scope of the claims herein. One of ordinary skill in the art would recognize other variations, modifications, and alternatives.

What is claimed is:

1. A method for managing information, comprising:
modeling a first plurality of information entities, including a first entity and a second entity, using a first logical model;
converting said logical model into a first derived subject model;
converting said first derived subject model into a first physical model; and
mapping at least one relationship between said first entity and said second entity of said first plurality of information entities based upon said first physical model.

2. The method of claim 1, said first logical model comprising at least one of a central concept entity, a static attribute entity, a dynamic attribute entity, an activities/events entity.

3. The method of claim 1, said first derived subject model comprising at least one of a core component, and at least one of a plurality of customized group components.

4. The method of claim 1, further comprising:
analyzing said first plurality of information entities using applications based upon input of said first logical model.

5. The method of claim 4, said applications comprising at least one of statistics, a report generator, an On Line Analytical Processing (OLAP) package, and a data mining application.

6. The method of claim 1, mapping at least one relationship between said first entity and said second entity of said first plurality of information entities based upon said first physical model comprises:
creating metadata information for said models; and
saving said metadata information in a repository.

7. The method of claim 1, further comprising:
modeling a second plurality of information entities, including a first entity and a second entity, using a second logical model;
converting said second logical model into a second derived subject model;
converting said second derived subject model into a second physical model; and
mapping at least one relationship among said first entity and said second entity of said second plurality of information entities based upon said second physical model.

8. The method of claim 7, further comprising:
analyzing said first plurality of information entities and said second plurality of information entities using applications based upon input from said first logical model and said second logical model, said applications deriving new relationships between said first plurality of information entities and said second plurality of information entities.

9. A system for managing data, comprising:
a computer;
an information store, operable to contain said data;
a database interface software process that maintains said data in said information store;
a metadata repository;
a query/command generator software process that provides access to said data;
a repository interface software process that provides access to said metadata;
a scheduler software process; and
a user interface software process that controls input to and output from said metadata repository, said database interface software process, said query/command generator software process, and said scheduler.

10. A computer program product for managing information, said computer program product comprising:
code that models a first plurality of information entities, including a first entity and a second entity, using a first logical model;
code that converts said logical model into a first derived subject model;
code that converts said first derived subject model into a first physical model;
code that maps at least one relationship among said first entity and said second entity of said first plurality of information entities based upon said first physical model; and
a computer readable storage medium for holding the codes.

11. The computer program product of claim 10, said first logical model comprising at least one of a central concept entity, a static attribute entity, a dynamic attribute entity, an activities/events entity.

12. The computer program product of claim 10, said first derived subject model comprising at least one of a core component, and at least one of a plurality of customized group components.

13. The computer program product of claim 10 further comprising:
code that analyzes said first plurality of information entities using applications based upon input of said first logical model.

14. The computer program product of claim 13, said applications comprising at least one of statistics, a report generator, an On Line Analytical Processing (OLAP) package, and a data mining application.

15. The computer program product of claim 10, wherein said code that maps at least one relationship between said first entity and said second entity of said first plurality of information entities based upon said first physical model comprises:
code that creates metadata information for said models; and
code that saves said metadata information in a repository.

16. The computer program product of claim 10, further comprising:
code that models a second plurality of information entities, including a first entity and a second entity, using a second logical model;
code that converts said second logical model into a second derived subject model;
code that converts said second derived subject model into a second physical model; and
code that maps at least one relationship among said first entity and said second entity of said second plurality of information entities based upon said second physical model.

17. The computer program of claim 16, further comprising:
code that analyzes said first plurality of information entities and said second plurality of information entities using applications based upon input from said first logical model and said second logical model, said applications deriving new relationships between said first plurality of information entities and said second plurality of information entities.

18. A computer memory, having stored thereon data, said data comprising:
a first central concept entity;
a first static attribute entity;
a first dynamic attribute entity; and
a first activities/events entity, wherein said first central concept entity, said first static attribute entity, said first dynamic attribute entity, and said first activities/events entity are related by a first subject model.

19. The computer memory of claim 18, said data further comprising:
a second central concept entity;
a second static attribute entity;
a second dynamic attribute entity; and
a second activities/events entity, wherein said second central concept entity, said second static attribute entity, said second dynamic attribute entity, and said second activities/events entity are related by a second subject model.

20. An apparatus for managing information, comprising:
a processor; and
a memory;
wherein said processor is operative to model a first plurality of information entities, including a first entity and a second entity, using a first logical model; said processor is further operative to convert said logical model into a first derived subject model; and to convert said first derived subject model into a first physical model; and thereupon to map at least one relationship between said first entity and said second entity of said first plurality of information entities based upon said first physical model; wherein said first entity and said second entity are stored in said memory.

21. The apparatus of claim 20, said first logical model comprising at least one of a central concept entity, a static attribute entity, a dynamic attribute entity, an activities/events entity.

22. The apparatus of claim 20, said first derived subject model comprising at least one of a core component, and at least one of a plurality of customized group components.

23. The apparatus of claim 20, wherein said processor is further operative to analyze said first plurality of information entities using applications based upon input of said first logical model.

24. The apparatus of claim 23, said applications comprising at least one of statistics, a report generator, an On Line Analytical Processing (OLAP) package, and a data mining application.

25. The apparatus of claim 20, wherein said processor is operative to:
create metadata information for said models; and
save said metadata information in a repository when said processor maps at least one relationship between said first entity and said second entity of said first plurality of information entities based upon said first physical model.

26. The apparatus of claim 20, wherein said processor is further operative to:
model a second plurality of information entities, including a first entity and a second entity, using a second logical model;
convert said second logical model into a second derived subject model;
convert said second derived subject model into a second physical model; and
map at least one relationship among said first entity and said second entity of said second plurality of information entities based upon said second physical model.

27. The apparatus of claim 26, wherein said processor is further operative to:
analyze said first plurality of information entities and said second plurality of information entities using applications based upon input from said first logical model and said second logical model, said applications deriving new relationships between said first plurality of information entities and said second plurality of information entities.

28. A client apparatus, comprising:
a processor;
a memory; and
a display; wherein said processor causes said display to:
display a first logical model, said first logical model modeling a first plurality of information entities, including a first entity and a second entity;
display a first derived subject model, said first derived subject model obtained from said logical model;
display a first physical model, said first physical model obtained from said first derived subject model; wherein at least one relationship between said first entity and said second entity of said first plurality of information entities exists based upon said first physical model.

29. The apparatus of claim 28, said first logical model comprising at least one of a central concept entity, a static attribute entity, a dynamic attribute entity, an activities/events entity.

30. The apparatus of claim 28, said first derived subject model comprising at least one of a core component, and at least one of a plurality of customized group components.

31. The apparatus of claim 28, wherein said processor is further operative to display a result obtained from analyzing said first plurality of information entities using applications based upon input of said first logical model.

32. The apparatus of claim 31, said applications comprising at least one of statistics, a report generator, an On Line Analytical Processing (OLAP) package, and a data mining application.

33. The apparatus of claim 28, wherein said processor is operative to:
display a result obtained from creating metadata information for said models; and saving said metadata information in a repository when said processor maps at least one relationship between said first entity and said second entity of said first plurality of information entities based upon said first physical model.

34. The apparatus of claim 28, wherein said processor is further operative to:
display a second logical model, said second logical model modeling a second plurality of information entities, including a first entity and a second entity;
display a second derived subject model obtained from said second logical model;
display a second physical model obtained from said second derived subject model;
wherein at least one relationship among said first entity and said second entity of said second plurality of information entities exists based upon said second physical model.

35. The apparatus of claim 34, wherein said processor is further operative to:
display a result obtained from analyzing said first plurality of information entities and said second plurality of information entities using applications based upon input from said first logical model and said second logical model, said applications deriving new relationships between said first plurality of information entities and said second plurality of information entities.

36. A method for managing information, comprising:
modeling a first plurality of information entities, including a first entity and a second entity, using a first logical model;
converting said logical model into a first physical model; and
mapping at least one relationship between said first entity and said second entity of said first plurality of information entities based upon said first physical model.

37. The method of claim 36, said first logical model comprising at least one of a central concept entity, a static attribute entity, a dynamic attribute entity, an activities/events entity.

38. The method of claim 36, further comprising:
analyzing said first plurality of information entities using applications based upon input of said first logical model.

39. The method of claim 38, said applications comprising at least one of statistics, a report generator, an On Line Analytical Processing (OLAP) package, and a data mining application.

40. The apparatus of claim 36, wherein mapping at least one relationship between said first entity and said second entity of said first plurality of information entities based upon said first physical model comprises:
creating metadata information for said models; and
saving said metadata information in a repository when said processor.

41. The method of claim 36, further comprising:
modeling a second plurality of information entities, including a first entity and a second entity, using a second logical model;
converting said second logical model into a second physical model; and
mapping at least one relationship among said first entity and said second entity of said second plurality of information entities based upon said second physical model.

42. The method of claim 41, further comprising:
analyzing said first plurality of information entities and said second plurality of information entities using applications based upon input from said first logical model and said second logical model, said applications deriving new relationships between said first plurality of information entities and said second plurality of information entities.

43. A computer program product for managing information, said computer program product comprising:
code that models a first plurality of information entities, including a first entity and a second entity, using a first logical model;
code that converts said logical model into a first physical model;
code that maps at least one relationship among said first entity and said second entity of said first plurality of information entities based upon said first physical model; and
a computer readable storage medium for holding the codes.

44. An apparatus for managing information, comprising:
a processor; and
a memory;
wherein said processor is operative to model a first plurality of information entities, including a first entity and a second entity, using a first logical model; said processor is further operative to convert said logical model into a first physical model; and thereupon to map at least one relationship between said first entity and said second entity of said first plurality of information entities based upon said first physical model; wherein said first entity and said second entity are stored in said memory.

45. A client apparatus, comprising:
a processor;
a memory; and
a display; wherein said processor causes said display to:
display a first logical model, said first logical model modeling a first plurality of information entities, including a first entity and a second entity;
display a first physical model, said first physical model obtained from said first logical model; wherein at least one relationship between said first entity and said second entity of said first plurality of information entities exists based upon said first physical model.

46. A method for analyzing information, comprising:
retrieving metadata information from a repository;
creating at least one of a plurality of commands based upon said metadata information;
sending said at least one of a plurality of commands to a database;
providing information received from said database responsive to said at least one of a plurality of commands to at least one of a plurality of applications; and
creating at least one of a plurality of reports from a result of said at least one of a plurality of applications.

47. The method of claim 46, wherein said metadata information comprises at least one of a model, a mapping, a derived attributes definition, and a profiling definition.

48. A computer program product for analyzing information, comprising:
code that retrieves metadata information from a repository;
code that creates at least one of a plurality of commands based upon said metadata information;
code sends said at least one of a plurality of commands to a database;
code that provides information received from said database responsive to said at least one of a plurality of commands to at least one of a plurality of applications;
code that creates at least one of a plurality of reports from a result of said at least one of a plurality of applications; and
a computer readable storage medium for storing the codes.

49. An apparatus for analyzing information, comprising:
a processor; and
a memory;
wherein said processor is operative to retrieve metadata information from a repository; create at least one of a plurality of commands based upon said metadata information; send said at least one of a plurality of commands to a database; provide information received from said database responsive to said at least one of a plurality of commands to at least one of a plurality of applications; and create at least one of a plurality of reports from a result of said at least one of a plurality of applications.

50. A client apparatus, comprising:
a processor;
a memory; and
a display; wherein said processor causes said display to display at least one of a plurality of reports from a result of at least one of a plurality of applications acting upon information received from a database responsive to at least one of a plurality of commands created based upon a metadata information retrieved from a repository.
